(19) United States
(12) Patent Application Publication
(10) Pub. No.: US 2018/0139055 A1
(43) Pub. Date: May 17, 2018

(54) PROTEIN BASED CRYPTOGRAPHY

(71) Applicant: Carlos Enrique Brathwaite, Brooklyn, NY (US)

(72) Inventor: Carlos Enrique Brathwaite, Brooklyn, NY (US)

(21) Appl. No.: 15/350,422

(22) Filed: Nov. 14, 2016

(51) Int. Cl. H04L 9/32; H04L 9/08

(52) U.S. Cl. CPC H04L 9/3247; H04L 2209/04; H04L 9/0861

(57) ABSTRACT

This invention is directed to a method of providing extra levels of encryption to a message by imposing a mask on top of an already encrypted message, wherein the mask sits on top of a protein folding of a sequence of amino acids.

### FIELD OF INVENTION

This invention is directed to a method of providing extra levels of encryption to a message by imposing a mask on top of an already encrypted message, wherein the mask is incorporated into a protein folding of a sequence of amino acids.

### BACKGROUND OF INVENTION

For thousands of years, people have tried to communicate with others in secret. Often, this was done by sending messages in a coded form. The code essentially replaces a word or letter or number with a different word or letter or number. Thus, the code uses a substitute to symbolize words, letters, or numbers. The code always uses the same substitute to symbolize the same words, letters, or numbers.

By encoding a message according to a particular code, it can be read only by someone that has the correct codebook that indicates what each new word or letter or number represents or symbolizes. In some cases, the only people with the code and codebook are the sender and the intended recipient. The code will provide the sender a way to change the message into a form that cannot be easily read and the codebook will provide the intended recipient with a way to change the message back into a form that can be easily read. Unfortunately, many codes have become known. Thus, it has become necessary to find better ways of disguising messages.

Ciphers provide a better means for disguising messages. A cipher is a method of changing plain text into a different form so that it cannot be read as plain text. Ciphers are algorithms or instructions for changing a small part of the message to something else called a cipher text. In this way, the message is encrypted before it is sent and then, once it is received, the message is decrypted by the recipient. In particular, the sender will write a message in plain text and then convert the message into cipher text using a cipher. After the recipient receives the cipher text message, the recipient will decrypt the cipher text message using a decipherer. The cipher text will be converted back into plain text, thereby allowing the recipient to be able to read the message as sent by the sender.

Cryptography

The art and science of writing and solving ciphers is called cryptography. In particular, cryptography involves encrypting and decrypting messages. Encryption is the process of turning a plain text message into a cipher text message. Decryption is the process of turning a cipher text message into a plain text message.

More recently, cryptography includes authentication, digital signatures, et cetera. This is done by using difficult mathematical problems as the basis for cryptographic techniques.

Another recent addition to cryptography involves the use of DNA. A plain text message is converted from ASCII into a DNA sequence cipher text message by way of an algorithm. The DNA sequence cipher text is converted back to an ASCII plain text message by way of an encryption/decryption key. Initially, three DNA bases were used to represent a single alphanumeric character. Because DNA has 4 bases (A, T, C, G), a maximum of 64 (4×4×4) ASCII characters can be formed. In order to represent the 256 extended ASCII characters, more DNA base pairs can be used to represent a single alphanumeric character.

The advantage of DNA encryption is that it provides a difficult mathematical problem that make it less likely that an attack on the message or data will be successful. DNA encryption can be made stronger by adding a mask to the cipher text. This can be done by way of a masking value generator, wherein the masking value is combined with the encrypted cipher text. In some cases, more than one mask can be combined with the encrypted cipher text. By doing this, the encrypted cipher text combined with one or more masks increases the mathematical difficult involved with a brute force attack. As the mathematical difficult of decrypting a masked cipher text is increased, the more resistant to a brute force attack the method of encryption will be.

Thus, it would be beneficial to identify one of the most difficult mathematical problems and use that problem as the basis for cryptographic techniques.

### SUMMARY OF THE INVENTION

Accordingly, it is the subject of this invention to use protein based cryptography to provide an additional layer of cryptography to prevent possible leakage of a message or data. In particular, using protein folding for the mask of a cipher text provides a very difficult mathematical problem and thus provides a lot of resistance from a brute force attack.

Thus, a method of this invention provides an extra level of encryption to a message or date by imposing a mask on top of an already encrypted message, wherein the mask is a protein folding of an amino acid sequence.

Protein based cryptography is based on one of the most difficult mathematical problems in physical chemistry today, which is protein folding. A method of the present disclosure uses the mathematical complexity of protein folding and the obscurity of synthetic amino acids to encrypt data. Additionally, a method of the present disclosure provides intermediate data protection by application of a new amino acid mask.

The “protein folding problem” consists of three closely related puzzles: (a) What is the folding code?; (b) What is the folding mechanism?; and (c) Can we predict the native structure of a protein from its amino acid sequence?

The complexity of synthetic amino acids continues to grow as new amino acids are created in labs every day. Currently, there are over 110,000 synthetic amino acids. This makes it very difficult to guess the folding of new amino acids sequences. By using this complexity as the basis for a folded protein based on a randomly generated amino acid sequence, wherein the amino acids can be natural, synthetic, or a combination of natural and synthetic, the folded protein serves to increases the work factor to decode to around 10¹⁰⁰. If a hacker tries to decode the protein fold at the rate of 100 billion a second, it would take longer than the age of the universe to find the correct protein fold.

Protein based cryptography is based on the protein folding of amino acid sequences. There are 22 naturally occurring amino acids, 20 of which genetically code. These 20 amino acids can be used in protein based cryptography.

Although only 20 amino acids are genetically coded, over 100 have been found in nature. Some of these have been detected in meteorites, especially in a type of meteorites known as carbonaceous chondrites. Microorganisms and plants often produce very uncommon amino acids, which can be found in peptidic antibiotics.

More recently, with the advent of synthetic biology many new amino acids have been synthetically created, thereby adding to the pool of amino acids that may be used in cryptography. Non-natural amino acids are non-proteinogenic amino acids that either occur naturally or are chemically synthesized. Whether utilized as building blocks, conformational constraints, molecular scaffolds or pharmacologically active products, non-natural amino acids represent a nearly infinite array of diverse structural elements for the development of new leads in peptidic and non-peptidic compounds. Due to their seemingly unlimited structural diversity and functional versatility, they are widely used as chiral building blocks and molecular scaffolds in constructing combinatorial libraries. Non-natural amino acids can be found at: libraries.http://www.sigmaaldrich.com/chemistry/chemistry-products.html?TablePage=16274965

Protein folding is the physical process by which a protein chain acquires its native three-dimensional structure. When a protein is mis-folded, the mis-folded protein causes diseases like amyloidosis, Alzheimer's disease, Huntington's disease, and Parkinson's disease. Medical research is looking into how and why proteins get mis-folded.

The protein folding structure is called a conformation assembly and it includes four configurations. Each of these four configurations must be correct in order for the conformation assembly to be correct, thereby ensuring that the protein formed is folded correctly. The first is called the primary structure, which is the linear structure of the peptide bonds. The second is called the secondary structure, which covers the backbone interactions, hydrogen bonds, alpha helix, and beta sheets. The third is called the tertiary structure, which covers high order of folding and distant interactions. The fourth is called quaternary structure, which covers bonding with polypeptides. See, e.g., http://people.math.sc.edu/dix/fold.pdf

A protein based cryptography protocol uses the folded protein's conformation assembly. For proper conformation assembly, all four structures must be correct. Each structure provides information for a proper conformation. For protein based cryptography, we can use the four structures as cryptography keys that can be used with an additional variable. Temperature can act as a secret variable to the cipher. This is the case because temperature affects the folding of protein. In particular, the primary, secondary, tertiary, and quaternary structures are all dependent on the temperature. A protein will fold differently depending on the temperature at which the protein is folded.

The protein based cryptography protocol inputs include: the primary structure having a linear structure with x coordinates; the secondary structure having a two-dimensional structure with x and y coordinates; the tertiary structure having a three-dimensional structure with x, y, and z coordinates; the quaternary structure having a three-dimensional structure with x, y, and z coordinates; and the temperature that the protein was folded at in Celsius degrees.

In one embodiment of the present invention, a protein mask will cover a newly encrypted message. The protein is composed of amino acids that are randomly generated to disguise the encoded message. The protein mask provides further protection against leakage of the encoded message by being folded.

Everyday cryptography algorithms are being stress tested and broken by hackers, and criminal groups. It is a constant battle to stay ahead of these groups. This method addresses this problem by adding another level of protection in the arsenal of defense. This method provides a difficult algorithm and transforms the numbers to DNA sequence adding to the hacker's confusion in trying to break the encryption. The hacker must have an understanding of both cryptography techniques and biotechnology to have any hope of breaking this system.

The method of the present disclosure also preferably provides an electronic signature comprised of a randomly generated amino acid sequence, wherein the amino acids may be naturally occurring or synthetic and will create a unique signature to ensure non-repudiation.

A method of encrypting includes the steps of:

converting a plain text message into a DNA sequence cipher text message;

using an amino acid generator to generate a random amino acid sequence to create an electronic signature comprised of amino acids (natural and synthetic), wherein the amino acid sequence electronic signature will be merged with the DNA sequence cipher text message.

using an amino acid generator to generate a random amino acid sequence to create a data mask equal to the size of the DNA sequence cipher text and amino acid sequence electronic signature;

superimposing the amino acid sequence data mask onto the DNA sequence cipher text message and amino acid sequence electronic signature to prevent data leakage, thereby creating a masked marker that encodes onto a primary protein structure of an amino acid sequence;

using a temperature generator to generate a random temperature that will be passed to the primary structure generator and sending that temperature value to the user for decryption;

creating an primary protein structure using N number of amino acids generators to generate randomly N number of amino acid sequences based on the temperature value sent from the temperature generator, wherein the number of amino acids of a primary protein structure will equal to the number of amino acids of the amino acid sequence data mask;

merging the amino acid sequence data mask (which includes the DNA sequence cipher text and amino acids electronic signature) and masked marker onto an amino acid sequence foundation primary structure, wherein the amino acid sequence foundation is a protein; and

folding of the primary structure into secondary, tertiary, and quaternary structures at a given specific temperature based on the random values generator.

At this point, the message is encrypted. It can be sent on the internet to another user for decryption using the proper software or for storage in a database in a local system to prevent unauthorized use of data.

A method of decrypting includes the steps of:

inputting into the program all 5 inputs: primary x value, secondary x and y values, tertiary x, y, and z values, and quaternary x, y and z values, and temperature in degrees in C.

If the values are correct the system will unfold the folded protein and remove the mask using the masked marker. The system will convert the message from DNA sequence cipher text message into an ASCII plain text message. The message can be verified by checking the amino acid sequence base electronic signature to ensure non-repudiation. If the values are incorrect the system will not unfold the message until all of the values are correct.

Unless otherwise defined, all technical and scientific terms used herein have the same meaning as commonly understood by one of ordinary skill in the art to which this invention belongs. The materials, methods, and examples provided herein are illustrative only and not intended to be limiting.

Implementation of the method and system of the present invention involves performing or completing certain selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

Although the present invention is described with regard to a “computer” on a “computer network”, it should be noted that optionally any device featuring a data processor and the ability to execute one or more instructions may be described as a computer, including but not limited to any type of personal computer (PC), a server, a cellular telephone, an IP telephone, a smart phone, a PDA (personal digital assistant), or a pager. Any two or more of such devices in communication with each other may optionally comprise a “computer network”.

### BRIEF DESCRIPTION OF THE DRAWINGS

FIG. 1 is a flow chart depicting the steps of encrypting and masking a message.

FIG. 2. is a flow chart depicting the steps of unmasking and decrypting a message.

### DETAILED DESCRIPTION OF THE INVENTION

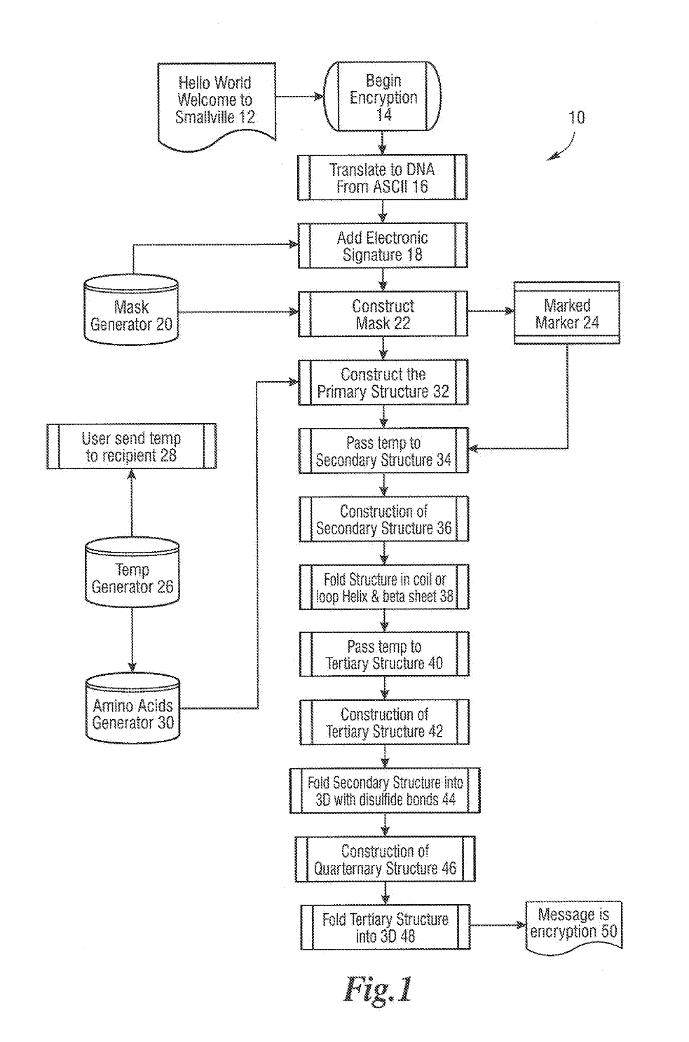

FIG. 1. depicts a method of encrypting a message 10 including the steps of: composing a plain text message 12; beginning encryption 14; converting the plain text message to a cipher text message by translating the plain text message from ASCII to DNA 16; adding an electronic signature to the cipher text message 18, wherein the electronic signature is created by random mask generator 20; constructing a mask to superimpose onto the cipher text message, wherein the mask is also created by a random mask generator 20; superimposing the mask onto the cipher text message, thereby creating a masked marker 24; obtaining a temperature from temperature generator 26; sending the recipient of the message the temperature generated by the temperature generator 28; obtaining a sequence of amino acids from amino acid generator 30; passing the temperature and the amino acid sequence to the masked marker and constructing the primary structure of the amino acid sequence, thereby creating a linear protein structure 32; passing the temperature to a secondary structure 34; constructing a secondary structure from the linear protein structure 36, wherein the secondary structure is folded into a coil or loop helix and beta sheet and is two dimensional 38; passing the temperature to a tertiary structure 40; constructing the tertiary structure from the secondary structure 42, wherein the tertiary structure is made from disulfide bonds and is three dimensional 44; constructing a quaternary structure from the tertiary structure 46, wherein the quaternary structure further folds the tertiary structure into a three dimensional structure; and obtaining a masked and encrypted message.

For visualization purposes, one can think of the process, by way of analogy only, as writing a message on a sheet of paper, scribbling over the message, placing a sheet of paper over the scribbled out message, then folding the sheet of paper into two dimensional, three dimensional, and further three dimensional structures, thereby completely covering the message. The folding of the paper can be thought of as being similar to Oragami, wherein there is a set of specific folds to form a two dimensional, three dimensional, and further three dimensional structure.

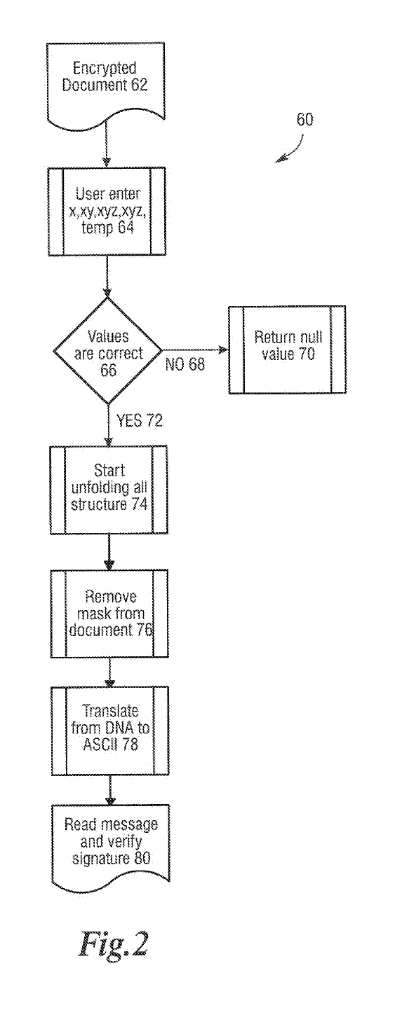

FIG. 2. depicts a method of decrypting a masked and encrypted message 60 including the steps of: receiving a masked and encrypted message or document 62; having previously received the input values, a system will verify whether the input values are correct 66; if the system verifies that the input values are not correct 68, then the system will return a null value to the user; if the system verifies that the input values are correct 72, then the system will begin unfolding the quaternary protein structure 74, thereby removing the mask from the cipher text message 76; translating the cipher text message from DNA to ASCII 78, thereby revealing a plain text message; and verifying the electronic signature prior to reading the message.

In another embodiment, this disclosure pertains to a method of using protein folding cryptography to provide an additional layer of cryptography to prevent possible leakage of a message by imposing a mask on top of an already encoded or encrypted message, wherein the mask is a protein folding of amino acids.

In one embodiment, the method of protein folding cryptography, may be built in a lab or may be a simulation in a computer security program.

In a preferred embodiment, the method of protein folding cryptography will be implemented by way of a computer security program. The steps will be simulated in a computer. The steps of a method of encryption include:

translating a plain text message from ASCII to a DNA sequence (this step is well known to those having ordinary skill in the art and thus will not be further described);

adding an electronic signature;

constructing a mask;

generating a random temperature;

constructing a protein by randomly generating a sequence of amino acids;

creating the primary protein folding structure;

creating the secondary protein folding structure;

creating the tertiary protein folding structure; and

creating the quaternary protein folding structure.

In a preferred embodiment, the electronic signature is a sequence of naturally occurring and/or synthetic amino acids for demonstrating the authenticity of a digital message or document. A valid electronic signature gives a recipient reason to believe that the message was created by a known sender, that the sender cannot deny having sent the message (authentication and non-repudiation), and that the message was not altered in transit (integrity).

In another embodiment, data masking is the process of providing a safeguard to original data without transforming it to intermediate data. In particular, data masking provides obscured data to the user and this data sent is called masked data. In masking methodology, it is not necessary to reconstruct original data from any intermediate data. This is the most fundamental difference between encryption and masking. In encryption, the original data is transformed into encrypted data and original data is retrieved from it. In contrast, in masking no transformation of the original data is necessary, rather the original data is directly protected. The most significant property of masking is that masking methodology is not reversible. The strength of masking methodology lies in the fact that masking should be done in such a way that there should not be any way to retrieve original data from masked data.

In another embodiment, a mask generator is a database inside of the computer system program that contains a listing of approximately 110,020 naturally occurring and synthetic amino acids that will be used to construct the mask. The mask generator will randomly select amino acids to safeguard the original data (also called a plain text message or original message) into intermediate data. This mask will be superimposed onto the original data. The system will give the mask a value. The mask value will be passed to the primary structure and will be encoded into that structure. At the time of decryption, the mask value will be used to remove the intermediate data, thereby leaving only the original data.

In another embodiment, the primary protein folding structure is based on the temperature selected. Protein folding behavior is dictated by temperature. The computer security program will access the temperature generator, which will select or generate a random temperature in Celsius.

Once a temperature has been selected, the temperature will be passed to the user and amino acid generator. The amino acid generator could be the same generator as the mask generator or a different one.

The amino acid generator will begin construction of the primary structure of the protein based on the temperature that was passed to it. The program will simulate building long chain, multiple amino acids that are linked together by peptide bonds. Peptide bonds are formed by a biochemical reaction that extracts a water molecule as it joins the amino group of one amino acid to the carboxyl group of a neighboring amino acid.

The user will pass the temperature to a recipient in an outband communication method, as part of a two-factor authentication.

After the primary protein structure has been completed, the mask (that is covering the original data) will be superimposed on to the primary protein structure. The primary structure is a linear structure of peptide bonds with x coordinates values. Along with the mask value that is required to decipher the masked message, the temperature will be passed onto the computer program to determine the secondary structure of the protein.

After receiving the temperature, the computer program will start forming the secondary structure, which includes the backbone interaction, hydrogen bonds, alpha helix and beta sheets of the protein. Forming a secondary structure with two-dimensions provides x and y coordinates with coils, loop helices, and beta sheets.

After receiving the temperature, the computer program will start folding the tertiary structure of the protein, which has a three-dimensional structure having x, y, and z coordinates. The tertiary structure with three-dimensions will have distant interactions with disulfide bonds.

After receiving the temperature, the computer program will start folding the protein into a quaternary structure, which is a three-dimensional structure having x, y, z coordinates.

After the quaternary structure of the protein is created, the message is masked and encrypted.

A method of decrypting includes the steps of:

receiving the temperature value by way of outband communication;

entering the temperature, x, (x, y), (x, y, z), and (x, y, z) values;

checking the entered values with known values of the folded protein;

unfolding the message and removing the mask based on the mask values; and verifying the amino acid sequence electronic signature; and

translating the DNA cipher text message to ACSII plain text message.

If the values are correct, the protein will unfold, but if the values are incorrect the protein will not unfold.

### Example

In one embodiment, a method of encrypting a message includes the steps of:

creating a message in plain text, for example: “Hello World, It is me in Smallville USA”;

converting the plain text message to a DNA sequence cipher text message by way of a random DNA sequence generator to CTAGGTACCTA GAAT ATG;

generating a protein base signature by way of a random amino acid generator, for example, C14H18ClNO— C3H7N1O2S1-C5H10FNO2;

superimposing the mask on the newly encrypted message, wherein the mask and message will look like, for example, C3H7NO2GACTAGGA C13H17NO5 AAGGTAGGC C9H10BrNO2 CTTAAAGGTATGGG AAGGTGA C9H11N1O2; and

obtaining a masked and encrypted message.

As is known in the art, coding for binary 0,1 to C,T, A and G for the DNA sequence is necessary for the transformation stage. The transformation stage is when the plain text message is converted to a DNA sequence cipher text message. For example “hello world” is transformed to CTTAGGA in the beginning prior to the mask being imposed on the DNA sequence cipher text message.

After the encryption phase, the DNA sequence cipher text message has a mask with the primary structure of a protein superimposed thereon. By way of example, the protein is created by building 100 amino acids chains. There are five random amino acid generators that include information about all of the amino acids both natural and synthetic. In this example, the first random amino acid generator will generate 20 amino acids at given temperature. That temperature will be sent to an additional four random amino acid generators, which will generate 20 amino acids chains each, there creating a protein made up of a sequence of 100 amino acids. The key factor of temperature given by the first random amino acid generator generator will determine the way in which the protein is folded along the entire 100 amino acid chain. The process of joining the amino acids into a polypeptide is called dehydration synthesis. After all of the amino acids have been joined together to complete the primary structure of the protein, the primary structure of the protein will be superimposed onto the DNA sequence cipher text message and this phase of encryption provides the x coordinates, which are inputs that are required for decryption.

The secondary structure covers the backbone interactions. The next step is to fold the primary protein structure into alpha helices and beta sheets with hydrogen bonds. This gives a two-dimensional protein structure with x and y coordinates. The tertiary structure will fold the protein structure into a three-dimensional structure with x, y and z coordinates. The quaternary structure will fold the protein into another three-dimensional structure with x, y, and z coordinates. The message is now completely masked and encrypted.

As discussed below, to unlock the mask, the protein needs to be unfolded by using all five inputs (the four structures of the protein—primary, secondary, tertiary, and quaternary, and the temperature).

In one embodiment, a method of decrypting an encrypted message includes the steps of:

a system prompting a user for the conformation of the folded protein;

the user entering the correct primary x, secondary x, y, tertiary x, y, z, quaternary x, y, z, and the temperature at which the protein is folded in Celsius degrees; and

if the conformation is correct, the protein will unfold the message and remove the mask and convert the DNA sequence cipher text message into an ASCII plain text message, thereby allowing the recipient of the message to read the message and to see the amino acid sequence electronic signature for non-repudiation; however, if the conformation is incorrect the message will remain folded.

It will be appreciated by those skilled in the art that while protein based cryptography has been described in detail herein, the invention is not necessarily so limited and other examples, embodiments, uses, modifications, and departures from the embodiments, examples, uses, and modifications may be made without departing from the process and all such embodiments are intended to be within the scope and spirit of the appended claims.

What is claimed is:

1. A non-transitory computer-readable medium; storing code, which when executed by one or more uses of a computer system, causes the system to implement a method of encrypting comprising the steps of:
converting an ASCII plain text message into a DNA sequence cipher text message;
using an amino acid generator to generate a sequence of random amino acids to create an amino acid sequence electronic signature, wherein the amino acid sequence electronic signature will be merged with the DNA sequence cipher text.
using an amino acid generator to generate a sequence of random amino acids to create an amino acid sequence data mask;
superimposing the amino acid sequence data mask onto the DNA sequence cipher text message and amino acid sequence electronic signature, thereby creating a masked marker;
using a random temperature generator to generate a random temperature that will be passed to a primary protein structure generator;
creating a primary protein structure using N number of amino acids generator to generate N number of random sequences of amino acids, wherein the primary protein structure of the N number of amino acid sequences is dependent on the temperature value sent from the random temperature generator;
merging the masked marker comprised of the amino acid sequence data mask, the DNA sequence cipher text, and the amino acid sequence electronic signature onto a primary protein structure of the N number of amino acid sequences; and
folding of the primary protein structure into secondary, tertiary, and quaternary protein structures at the temperature value generated by the random temperature generator; and
obtaining a masked and encrypted message.

2. The method of claim 1, wherein the amino acids are natural or synthetic.

3. The method of claim 2, wherein the DNA sequence cipher text is the same size as the amino acid sequence electronic signature.

4. The method of claim 2, wherein the DNA sequence cipher text is the same size as the amino acid sequence data mask.

5. The method of claim 2, wherein the DNA sequence cipher text is the same size as the N number of amino acid sequences.

6. The method of claim 1, wherein N=5.

7. The method of claim 1, wherein the number of amino acids in each N number of amino acid sequences is 20.

8. The method of claim 1, wherein the number of amino acids in the amino acid sequence of the protein is 100.

9. A method of encrypting and masking a message comprising the steps of:
composing a plain text message;
converting the plain text message to a cipher text message;
adding an electronic signature to the cipher text message, wherein the electronic signature is created by a random mask generator;
constructing a mask to superimpose onto the cipher text message, wherein the mask is created by a random electronic signature generator;
superimposing the mask onto the cipher text message, thereby creating a marked marker;
obtaining a temperature from a random temperature generator;
obtaining a sequence of amino acids from an amino acid generator; and
passing the temperature and the amino acid sequence to the marked marker and constructing a primary protein structure of the amino acid sequence, thereby creating a linear protein structure.

10. The method of claim 9, wherein the plain text message is an ASCII plain text message and cipher text message is a DNA sequence cipher text message.

11. The method of claim 9, wherein the method further includes the step of sending a recipient of the cipher text message the temperature generated by the random temperature generator.

12. The method of claim 9, wherein the method further includes the step of passing the temperature to a secondary structure and constructing a secondary structure from the linear protein structure; wherein the secondary structure is folded into a coil or loop helix and beta sheet and is two dimensional;

13. The method of claim 12, wherein the method further includes the step of passing the temperature to a tertiary structure and constructing the tertiary structure from the secondary structure, wherein the tertiary structure is made from disulfide bonds and is three dimensional.

14. The method of claim 13, wherein the method further includes the step of constructing a quaternary structure from the tertiary structure, wherein the quaternary structure further folds the tertiary structure into a three dimensional structure; and obtaining a masked and encrypted message.

15. A method of decrying an encrypted and masked message, comprising steps of:
receiving a masked and encrypted message or document;
inputting previously received input values into a system to verify whether the input values are correct;
awaiting a null value from the system if the input values are incorrect or awaiting the system to begin unfolding the quaternary protein structure, thereby removing the mask from the cipher text message if the input values are correct;
translating the cipher text message from DNA to ASCII, thereby revealing a plain text message;
and verifying the electronic signature prior to reading the message.
